(19) United States
(12) Patent Application Publication
(10) Pub. No.: US 2013/0334087 A1
(43) Pub. Date: Dec. 19, 2013

(54) LABEL AND METHOD FOR MANUFACTURING SUCH A LABEL

(71) Applicant: REYNDERS ETIKETTEN, Boechout (BE)

(72) Inventor: Marc REYNDERS, Vremde (BE)

(21) Appl. No.: 13/914,922

(22) Filed: Jun. 11, 2013

(30) Foreign Application Priority Data
Jun. 13, 2012 (BE) 2012/0394

(51) Int. Cl. G09F 3/00; B31D 1/02; B65D 25/34

(52) U.S. Cl. CPC G09F 3/0289; B65D 25/34; B31D 1/027
USPC 206/459.5; 53/397; 428/43; 427/256; 101/129

(57) ABSTRACT

Label (1) intended to be placed around a container (13) for a product, and this label (1) is strip-shaped and provided with a weakening that forms the dividing line (9) between two parts (2, 3), i.e. a first (2) part and a second part (3) that are in line with one another, whereby the second part (3) is provided with at least one window (10), characterised in that the second part (3) is narrower than the first part (2) and the first part (2) is provided with a thickening (6) that is outside the geometric extension (8) of the second part (3) in the direction of the first part (2).

The present invention relates to a label and a method for manufacturing such a label.

More specifically the invention concerns a label that consists of at least two parts, i.e. a first part that is intended to be immovably placed on a container and a second part that is intended to form a turnable sleeve over the first part that can be torn off from the first part, whereby the second part is provided with at least one window such that information on the first part can be seen during use.

Such a label is known from U.S. Pat. No. 6,649,007, whereby the window is used for selectively displaying safety and storage information for a medicine and screening off information that is less applicable.

However, with such a label the sleeve can slide off the underlying first part. Hence such a label can only be used on a container that is provided with a recessed part for the label, or with raised edges. These containers are more difficult to manufacture than containers with a smooth cylindrical wall, which results in a higher cost price.

Also with regard to the known labels there is a lack of flexibility in the usage, because the distance between the edges on the container and the height of the label must be harmonised to one another.

A further disadvantage is that it can easily happen that the chosen position of the cover is accidentally changed, such that information that does not apply is displayed and information that does apply is not displayed.

The purpose of the present invention is to provide a solution to at least one of the aforementioned and other disadvantages, by providing a label intended to be placed around a container for a product, and this label is strip-shaped and provided with a weakening that forms the dividing line between two parts, i.e. a first part and a second part that are in line with one another, whereby the second part is provided with at least one window, whereby the second part is narrower than the first part and the first part is provided with a thickening that is outside the geometric extension of the second part in the direction of the first part.

This has the advantage that this label can be used on containers that are free of edges, thus cheaper, while nevertheless a sleeve that is formed by the second part cannot move with respect to the first part during use, and cannot slide of the container.

Labels according to the invention of a given width can be applied to a wide variety of containers, and the width of the label no longer needs to be adapted to the container.

Hereby, the window can be formed by an opening in the label, or by a transparent zone in the label.

In practice, and in a preferred embodiment, the first part is provided with two thickenings, whereby the distance between the thickenings is greater than the width of the second part and the thickenings form ridges.

In a further preferred embodiment the thickening or thickenings has or have a thickness of between 0.1 and 1 millimetre, i.e. the distance by which they project above the surface of the first part, and more preferably between 0.12 and 0.3 mm.

A good operation is assured with the said thickness. Also an unnecessary thickness and thus material consumption and detrimental visual consequences are avoided.

In another preferred embodiment the thickening or thickenings is or are essentially formed by ink that is applied by means of screen printing.

In this way the said thickenings can be made easily, cheaply and accurately.

Alternatively the thickenings can also be applied by other techniques such as by deforming the substrate from which the label is made, by printing with an expanding ink, by injecting relatively viscous ink, and by means of other techniques known in the field.

A practical application of the label is for a container for drugs.

In a further preferred embodiment the label is provided with means that enable a sleeve formed from the second part to be temporarily or permanently secured during use in a certain rotational position.

This is primarily of importance when the labels are for containers for drugs, whereby the window contains information attuned to a specific patient, for example dosage information that depends on the weight or age of the patient.

In order to prevent this information being lost due to the cover accidentally being turned in the wrong position, in the preferred embodiment a person with knowledge of the facts, for example a doctor, nurse or pharmacist, can place the sleeve in the right position and secure it there so that undesired turning is prevented.

The means that enable the turnable cover to be temporarily or permanently secured in a certain turned position can be zones with adhesive, for example, that can be activated by heat or moisture for example.

The invention also relates to a method for manufacturing a label, whereby the label is strip-shaped and provided with a weakening that forms the dividing line between two parts, i.e. a first part and a second part that are in line with one another, whereby the second part is provided with at least one window and is narrower than the first part, whereby a step in the method is: the application of at least one thickening on the first part at a position that is outside the geometric extension of the second part in the direction of the first part.

The invention further concerns a method for manufacturing a container for a product that is provided with a label, and this label comprises at least two parts. A first part that is placed immovably on the container and a second part that forms a turnable sleeve over the first part, whereby the second part is provided with a least one window such that information on the first part can be seen during use, and whereby the container with the label is provided with at least one thickening to prevent an axial movement of the sleeve, whereby this thickening is placed on the container together with the label.

With the intention of better showing the characteristics of the invention, a few preferred embodiments of a label and container according to the invention and methods according to the invention are described hereinafter by way of an example, without any limiting nature, with reference to the accompanying drawings, wherein:

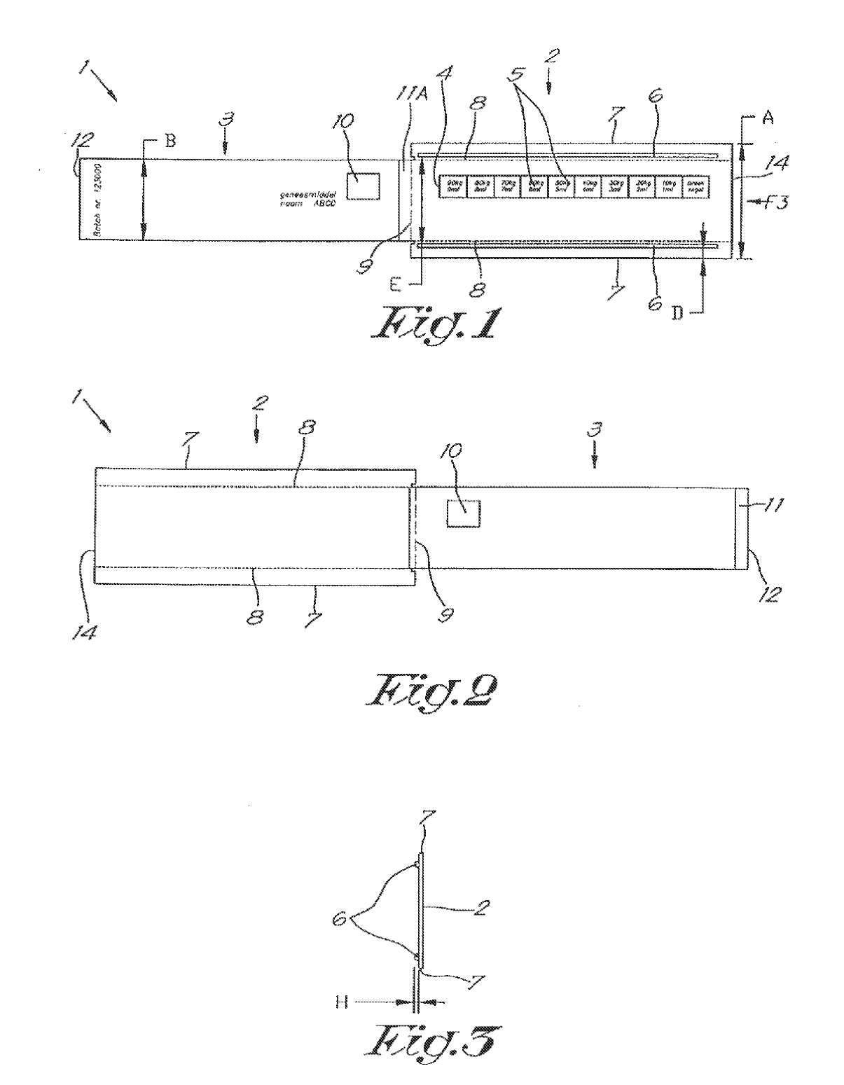

FIG. 1 shows a view of the front of a label according to the invention;

FIG. 2 shows a view of the back of the label of FIG. 1;

FIG. 3 shows a side view according to F3 of the label of FIG. 1;

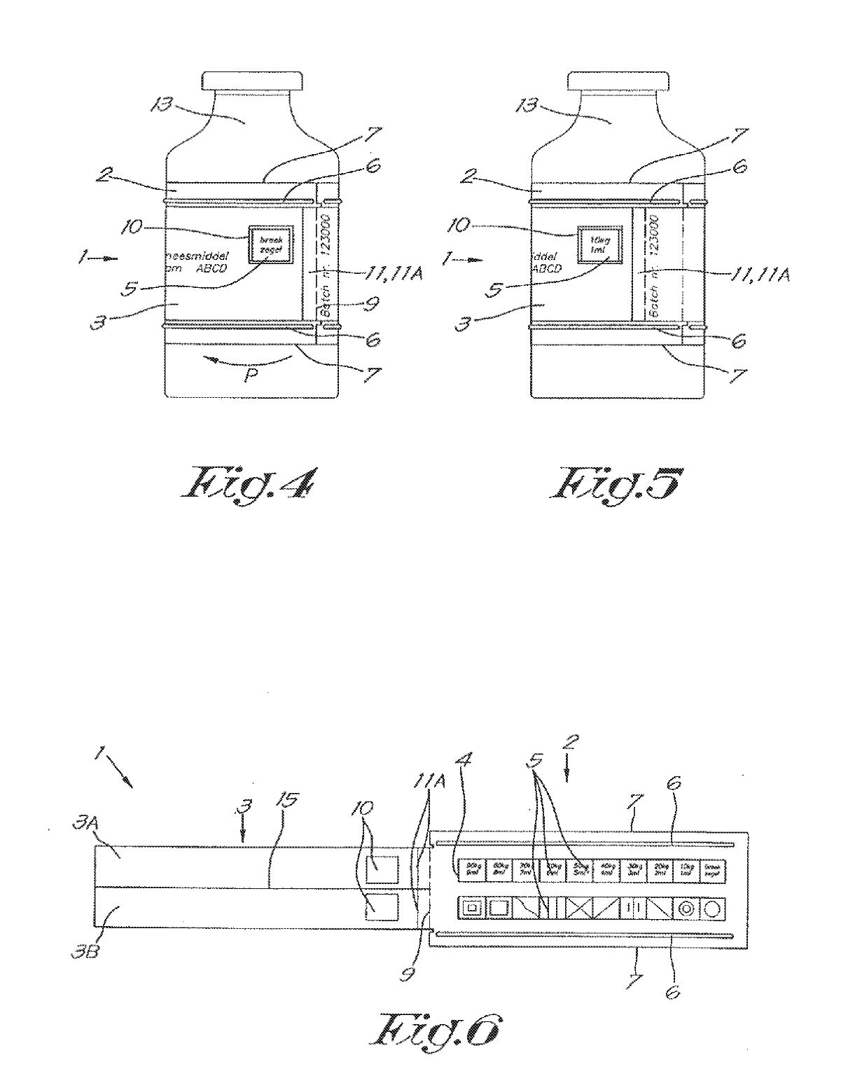

FIGS. 4 and 5 show a container according to the invention in two different usage positions; and

FIG. 6 shows a view of the front of an alternative embodiment of the label according to the invention.

The label 1 shown in FIGS. 1 to 3, in this example for a container for a liquid medicine, is strip-shaped and comprises a first part 2 with a width A and a second part 3 with a smaller width B.

On the front, i.e. the side that is intended to be seen by the end user, the label 1 is provided with an instruction bar 4 on the first part 2. This instruction bar 4 consists of a number of sections 5, which in this specific example each show a weight and a dosage.

On the first part 2 there are also two thickenings in the form of ridges 6, at a distance D from the top and bottom edges V. These ridges 6 have a thickness H of approximately 0.2 mm, i.e. they protrude approximately 0.2 mm above the surface of the first part 2 and are a distance apart E.

D is hereby smaller than 0.5*(A−B) so that the ridges 6 are closer to the edges 7 than the geometric extension 8 of the second part 3 shown in dotted lines, thus outside this geometric extension 8.

A perforated line 9 is made in the label 1 that forms the dividing line between the first part 2 and the second part 3.

In this example but not exclusively, the label 1 is manufactured from transparent polypropylene film that is printed on one side, whereby a window 10 in the second part 3 is left transparent. This window 10 is somewhat larger than a section 5. Instead of polypropylene film other substrates can be used for this, whereby in general polyolefin films are eminently suitable.

On the back of the label 1, as is essentially clear from FIG. 2, the label 1 is provided with adhesive at the location of the first part 2.

At the location of the second part 3 the label is not provided with an adhesive on its back, or may be provided with an adhesive that is neutralised, except for an adhesive zone 11 close to the end 12 of the second part 3 remote from the first part 2, where adhesive is applied.

Such a label can be manufactured as follows:

A strip of transparent polypropylene is cut to the desired size with known techniques and a perforated line 9 is made in it. Then this strip is printed with the necessary information, whereby it is ensured that the window 10 is not printed. Then adhesive is applied where necessary.

Then the two ridges 6 are made by means of screen printing, which primarily consist of screen printing ink, after which the label 1 is ready to be placed around a container.

In order to place the label on a container the label 1 is wound on a roll together with a number of other similar labels 1.

Alternatively the ridges 6 can be made with other techniques, whereby preferably an expandable ink is used, which after applying a thin layer can expand to form a ridge 6.

The above manufacturing steps can also be done in a different order.

The use of a label 1 is simple and as follows.

An empty unprinted container 13 for liquid drugs is taken, with a flat cylindrical wall, thus without edges or transitions.

The dimensions of the label 1 and the diameter of the container 13 are harmonised to one another. This means that the first part 2 of the label 1 is shorter than the circumference of the container 13 and that the second part 3 is longer than the circumference of the container, even if the adhesive zone 11 is left out of consideration.

The back of the end 14 remote from the adhesive zone 11 of a label 1 is placed on the container. With a continuous rolling movement of the container 13 the label 1 is now placed in one go, whereby the first part 2 is stuck to the container 13 with a first rotation, after which the second part 3 is wound around the container 13 and around the first part 3 in a second rotation.

Hereby the adhesive zone 11 attaches to the front of the second part 3 only in the zone indicated by 11A in FIG. 1. As a result, as shown in FIG. 4, the second part 3 forms a sleeve around the first part 2. At this moment the sleeve is stuck to the first part 2 via the perforated line 9 and thus to the container 13.

Due to the positioning of the ridges 6 and the width B of the second part, the sleeve is between the ridges 6.

The positioning of the bar 4 is such that the instruction can be seen through the window 10 to break the seal. This seal is formed by the perforated line 9.

When a dosage has to be indicated, the user holds the sleeve with one hand and the container 13 with the other hand and turns it in the direction of the arrow P. As a result the sleeve tears on the perforated line 9 from the first part 2 and is thereby freely rotatable.

As shown in FIG. 5 the window 10 can now be placed over the section 5 with the desired dosage, so that only this, and no other, dosage can be seen for the user.

The ridges 6 hereby prevent the cover being able to be moved in its axial direction with respect to the first part 2 of the label 1 and with respect to the container 13.

By breaking the seal, in other words the separation of the cover and the first part 2, it is clear that the medicine has already been issued, so that fraud is impeded.

Of course to this end the dimensions of the second part 3 and the height of the ridges 6 must be such that the circumference of the sleeve is greater than the circumference of the container 13 with the first part 2, so that the cover can freely move, but smaller than the circumference of the ridges 6.

The label 1 shown in FIG. 6 differs from the label 1 described above because the second part 3 consists of two sub-parts (3A, 3B) that are not connected together sideways, but are separated by a cut 15.

This enables two separate sleeves to be formed when the label 1 is used, so that sections 5 of separate bars 4 can be selected in the windows 10 such that more information can be made visible in a flexible way.

The present invention is by no means limited to the embodiments described as an example and shown in the drawings, but a label and methods according to the invention can be realised in all kinds of variants, without departing from the scope of the invention.

1. Label (1) intended to be placed around a container (13) for a product, and this label (1) is strip-shaped and provided with a weakening that forms the dividing line (9) between two parts (2, 3), i.e. a first (2) part and a second part (3) that are in line with one another, whereby the second part (3) is provided with at least one window (10), characterised in that the second part (3) is narrower than the first part (2) and the first part (2) is provided with a thickening (6) that is outside the geometric extension (8) of the second part (3) in the direction of the first part (2).

2. Label (1) according to claim 1, characterised in that the first part (2) is provided with two thickenings (6), whereby the distance (E) between the thickenings (6) is greater than the width (B) of the second part (3).

3. Label (1) according to claim 1, characterised in that the thickening or thickenings form a ridge or ridges (6).

4. Label (1) according to claim 3, characterised in that the ridge or ridges (6) extend over at least the largest portion of the first part (2).

5. Label (1) according to claim 1, characterised in that the thickening or thickenings (6) have a thickness (H) of between 0.1 and 1 millimetre.

6. Label (1) according to claim 1, characterised in that the thickening or thickenings (6) is or are applied by a printing technique.

7. Label (1) according to claim 1, characterised in that the thickening or thickenings (6) is or are essentially formed by ink applied by means of screen printing.

8. Label (1) according to claim 1, characterised in that the second part (3) comprises connecting. zones (11, 11A) at or near two edges located opposite one another that are arranged to overlap one another during use and to be adhered together to form a sleeve from the second part (3).

9. Label (1) according to claim 1, characterised in that the first part (2) is intended to be immovably placed on a container (13) for a product, the second part (3) is intended to form a turnable sleeve over the first part (2) during use whereby information present on the first part (2) can be seen through the window (10) and that the thickening or thickenings (6) prevent the sleeve from being able to move in its axial direction with respect to the first part (2) during use.

10. Label (1) according to claim 1, characterised in that it is provided with means that enable a sleeve formed from the second part (2) to be temporarily or permanently secured in a certain rotational position during use.

11. Container (13) for a product, that is provided with label (1) according to claim 1, whereby the first part (2) is placed on the container (13), and the second part (3) is placed around the container (13) and around the first part (2).

12. Container (13) according to claim 9, characterised in that it has a wall that is free of edges or transitions that can prevent, during use, a sleeve formed from the second part (3) from being able to move axially.

13. Method for manufacturing a label (1), whereby the label (1) is strip-shaped and provided with a weakening that forms the dividing line (9) between two parts, i.e. a first part (2) and a second part (3) that are in line with one another, whereby the second part (3) is provided with at least one window (10) and is narrower than the first part (2), characterised in that a step in the method is: the application of at least one thickening (6) on the first part (2) at a position that is outside the geometric extension (8) of the second part (3) in the direction of the first part (2).

14. Method according to claim 13, characterised in that two thickenings (6) are applied with a distance (E) between them that is greater than the width (13) of the second part (3).

15. Method according to claim 13, characterised in that the thickening or thickenings forms or form a ridge or ridges (6).

16. Method according to claim 13, characterised in that the thickening or thickenings (6) is or are applied by a printing stage.

17. Method according to claim 13, characterised in that the thickening or thickenings (6) is or are applied by screen printing.

18. Method for manufacturing a container (13) for a product that is provided with a label (1), and this label (1) comprises at least two parts, i.e. a first part (2) that is placed immovably on the container (13) and a second part (3) that forms a turnable sleeve over the first part (2), whereby the second part (3) is provided with a least one window (10) such that information on the first part (2) can be seen during use, and whereby the container (13) with the label (1) is provided with at least one thickening (6) to prevent an axial movement of the sleeve, characterised in that the at least one thickening (6) is placed on the container (13) together with the label (1).

19. Method according to claim 18, characterised in that a label (1) is strip-shaped and provided with a weakening that forms the dividing line (9) between the first (2) and the second part (3) that are in line with one another, the second part (3) is narrower than the first part (2), and the thickening (6) is outside the geometric extension (8) of the second part (3) in the direction of the first part (2), whereby this label (1) is placed on the container (13) by means of a continuous rotational movement of the container (13), with the first part (2) first.

20. Method according to claim 18, characterised in that the label (1) is strip-shaped and provided with a weakening that forms the dividing line (9) between the first (2) and the second part (3) that are in line with one another, whereby the second part (3) is narrower than the first part (2), the label (1) being is manufactured by the application of at least one thickening (6) on the first part (2) at a position that is outside the geometric extension (8) of the second part (3) in the direction of the first part (2).
